(19) United States
(12) Patent Application Publication
(10) Pub. No.: US 2005/0104534 A1
(43) Pub. Date: May 19, 2005

(54) Operating circuit and operating method for a gas discharge lamp

(76) Inventors: Werner Ludorf, Ruhpolding (DE); Marco Seibt, Ruhpolding (DE)

Correspondence Address: Leopold Presser;Scully, Scott, Murphy & Presser, 400 Garden City Plaza, Garden City, NY, 11530, US

(21) Appl. No.: 10/987,798

(22) Filed: Nov. 12, 2004

(30) Foreign Application Priority Data
Nov. 15, 2003 (DE) 103 53 425.3

(51) Int. Cl. H05B 37/02

(52) U.S. Cl. 315/209 R; 315/224; 315/294; 315/291

(57) ABSTRACT

In an operating circuit for a gas discharge lamp 1, in particular in the aeronautical field, an inductance L1 is connected upstream of the gas discharge lamp 1 and a switch V3 periodically controlled by an electronic control system 3 controls the current through the inductance L1. In order also to be able to achieve very low dimming values with freedom from flicker, by virtue of the switch V3 being switched into a conducting condition by means of the electronic control system 3 a constant dc voltage Uᵢₙ is applied to the inductance L1 for a constant switch-on duration tₒₙ. By the switch V3 being switched off at the end of the switch-on duration tₒₙ the energy stored by the inductance L1 is discharged to the gas discharge lamp 1. In each case after discharge of the inductance L1 the electronic control system 3 closes the switch V3 periodically again for the switch-on duration tₒₙ.

The invention concerns an operating circuit and an operating method for a gas discharge lamp, in particular a fluorescent lamp, in particular in the aeronautical field.

A circuit of that nature is described in DE 40 13 360 C2 for operation on an ac mains network. That arrangement provides that the lamp lights with maximum brightness even when the nominal value of the mains ac voltage is comparatively low, without a transformer being required.

A further circuit for starting and brightness control of a fluorescent lamp on an ac mains network is described in EP 0 471 331 B1.

In modern passenger aircraft there is a wish for lighting which can be dimmed continuously to very low dimming values. The lower dimming limit should be far below 1%, in particular having regard to the transition from darkness to that lower dimming limit. For, because of the logarithmic sensitivity curve of the eye, a dimming value of 1%, starting from darkness, is already perceived as being relatively bright. The wish to be able to mix the light of different light sources as desired can also only be satisfied with very low dimming levels. In any event flicker phenomena are to be avoided.

In operation with dc voltage, high degrees of dimming are admittedly possible, in comparison with operation using ac voltage. However an undesirable flicker effect can occur.

Prior German patent application No 102 52 979 describes a method of operating a gas discharge lamp, with which the gas discharge lamp can be operated in flicker-free manner. Voltage pulses are superimposed on a dc voltage component which can be reduced to zero.

When the lamp is supplied from a dc source, it must have a suitable regulating characteristic. The demands made on the regulating speed are different because of the greatly variable lamp parameters and thus cause difficulties in terms of design configuration and dimensioning of the dc source. In addition, when there is a change in the ambient temperature, there is a change in the lamp resistance and thus an unwanted change in the lamp output. Regulation to a constant lamp output is complicated and expensive (see DE 100 51 139 A1).

The object of the invention is to propose an operating circuit and an operating method of the kind set forth in the opening part of this specification, with which low dimming values, below 1%, are achieved, with freedom from flicker.

According to the invention the foregoing object is attained by the features of claims 1 and 13 respectively.

In that respect the gas discharge lamp is supplied with a direct current from the energy of the inductance, such energy being controlled periodically during the switch-on duration. The direct current flowing during the switch-off duration of the switch is always set, without a regulating circuit, in such a way that the lamp receives a constant energy, even when lamp parameters change. The switch-off duration changes with the respective lamp resistance.

This therefore provides a stable, flicker-free lighting characteristic on the part of the gas discharge lamp at all dimming values. A wide dimming range down to below a dimming value of <about 1% can be easily achieved by changing the stored energy of the inductance. For that purpose the switch-on duration is suitably changed by the electronic control system. The dimming effect can also be influenced by changing the applied dc voltage.

The frequency of the period is so high that there is no possibility of visibility. Preferably it is greater than 100 kHz.

Firing of the lamp is effected by the energy of the inductance.

The circuit is suitable for the operation of all discharge lamps, in particular for the lighting arrangement in aircraft passenger cabins or passenger trains. The circuit can also be used when there is a wish for variable-colour mood lighting, in which case colour mixes can be continuously achieved by fine graduations in the dimming values of the lamps of different light colours. It is advantageously used in aircraft involving different on-board mains system frequencies with fluorescent lamps and possible low lighting levels such as night time lighting arrangements and mood lighting arrangements.

Advantageous configurations of the invention are set forth in the appendant claims and the following description. In the drawing:

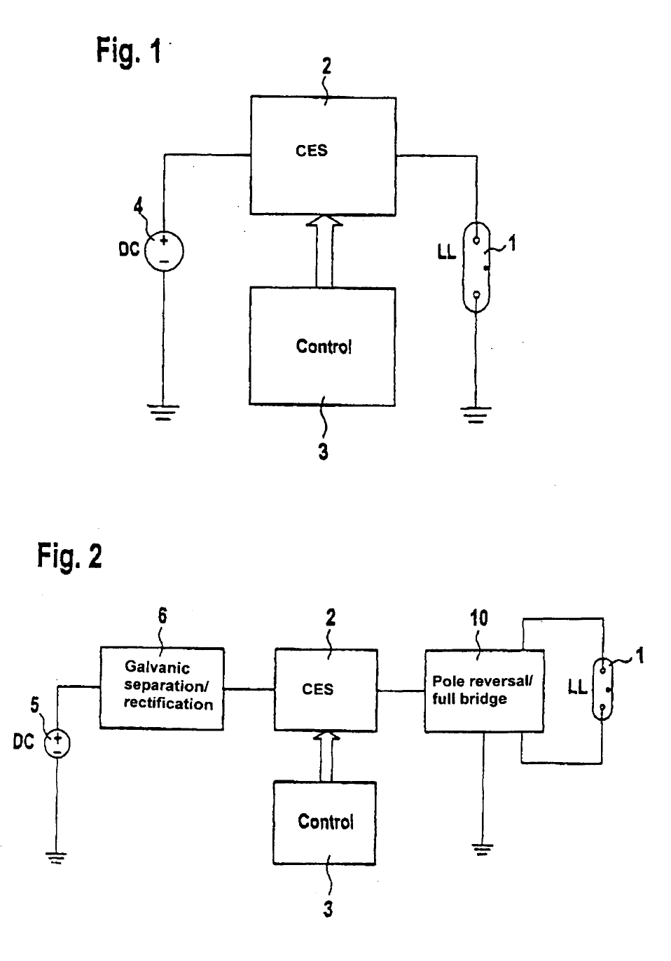

FIG. 1 shows a dc voltage-supplied operating circuit of a fluorescent lamp,

FIG. 2 shows an expansion of the circuit shown in FIG. 1 with galvanic separation of the supply network and pole reversal of the fluorescent lamp,

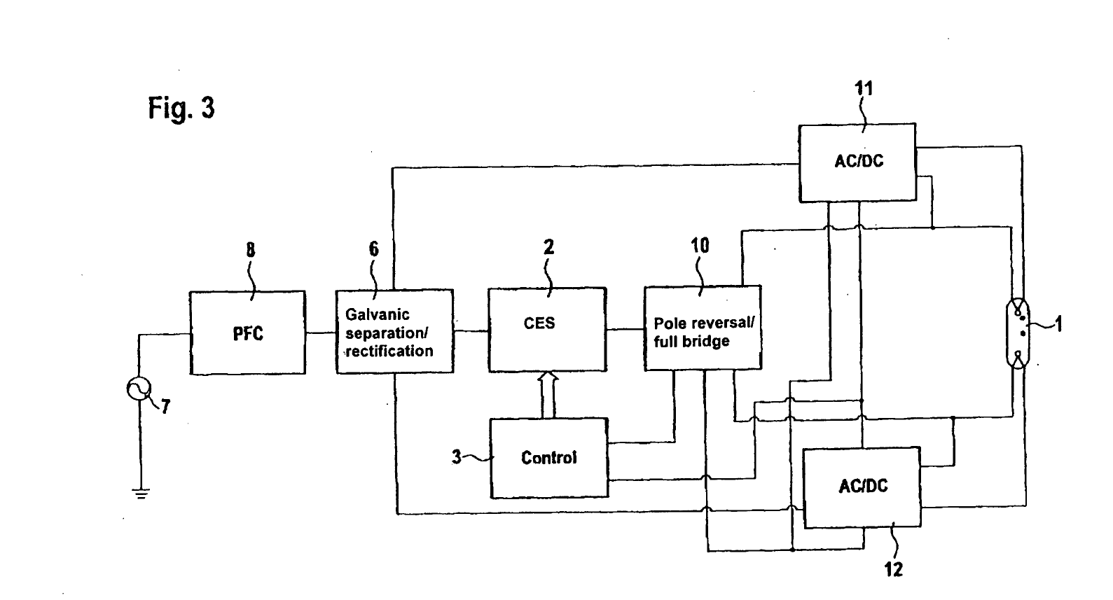

FIG. 3 shows an expanded operating circuit on an ac network with galvanic separation, rectification and pole reversal as well as coil heating,

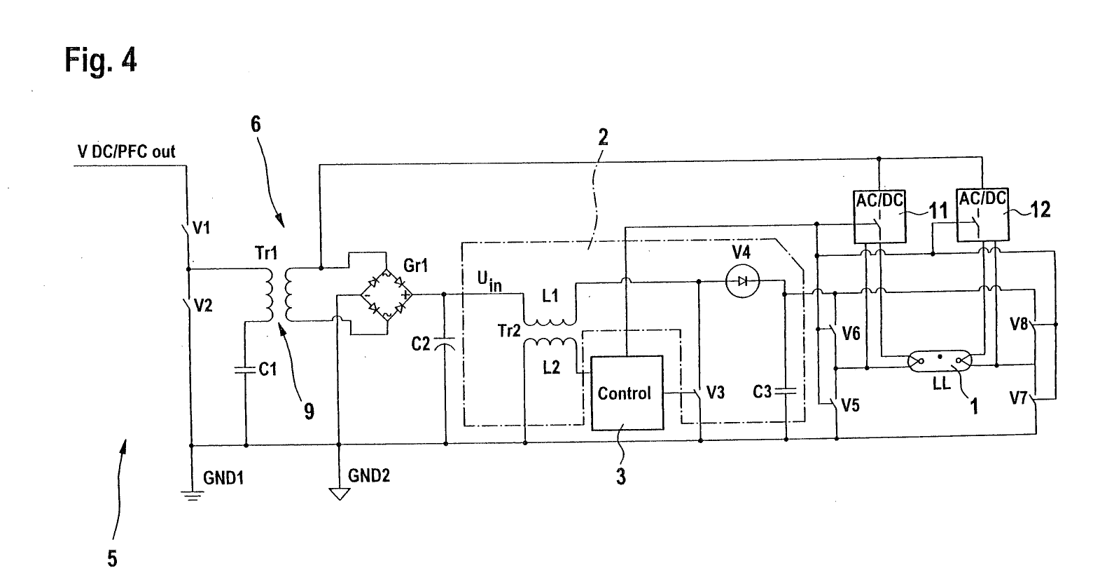

FIG. 4 is a detailed view showing the operating circuit of FIG. 3, and

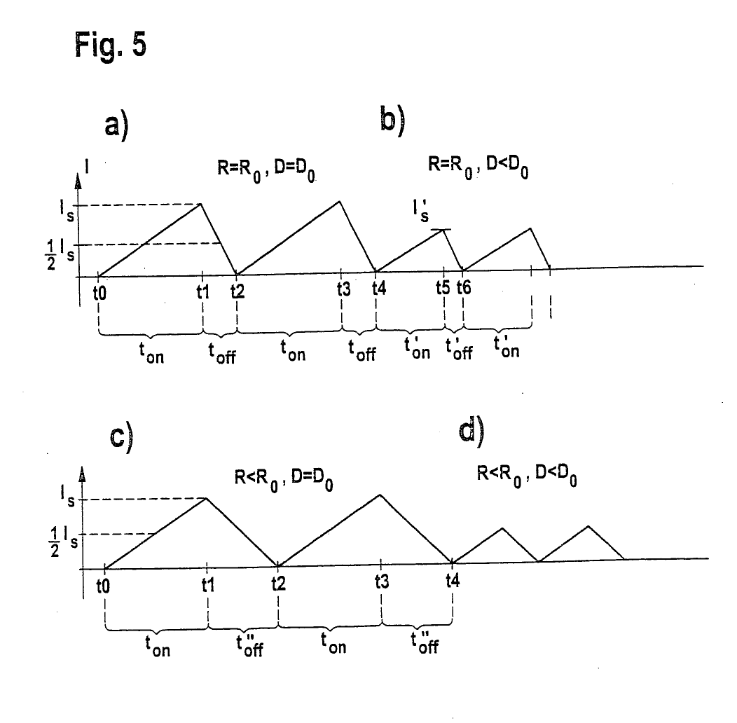

FIG. 5 shows current configuration examples at the inductance.

Connected upstream of a fluorescent lamp 1 or a series connection of fluorescent lamps 1 is a constant energy source 2 which is controlled by an electronic control system 3 and fed by a dc voltage source 4 (see FIG. 1). The dc voltage source 4 can be a battery, an on-board dc network 5 with a galvanic separation and rectifier stage 6 (see FIG. 2), an on-board ac network 7, for example a 115 V network of an aircraft, with a power factor control (PFC) 8 and a galvanic separation and rectifier stage 6 (see FIG. 3). The stage 6 has for example a transformer 9 or an electronic transformer Tr1 with electronic switches V1, V2, capacitor C1 and a bridge rectifier Gr1 with a smoothing capacitor C2 (see FIG. 4). The electronic control system 3 can obtain its supply voltage from the stage 6. In all connection situations an input dc voltage Uᵢₙ occurs at the input of the constant energy source 2.

The constant energy source 2 has an inductance L1 in series with the fluorescent lamp 1, and a switch V3, for example a transistor switch, in parallel with the fluorescent lamp 1, which is switched periodically by the electronic control system 3. An inductance L2 which is coupled in transformer relationship with the inductance L1 is connected to the electronic control system 3. A storage capacitor C2 is connected in parallel with the fluorescent lamp 1. Provided between the inductance L1 and the fluorescent lamp 1 is a diode V4 so that the storage capacitor C3 is not short-circuited when the switch V3 is conducting, that is to say closed (see FIG. 4).

The mode of operation of the constant energy source 2 is substantially as follows:

At the time t0 (see FIG. 5) the electronic control system 3 closes the switch V3. In that situation, under the voltage Uᵢₙ, the current I flowing through the inductance L1 rises linearly. Upon expiry of the switch-on duration tₒₙ which is determined by the electronic control system 3—at the time t1—the electronic control system 3 opens the switch V3, that is to say switches it into the non-conducting condition. Until then the current I has risen linearly to the value Is (see FIG. 5). In that situation the power P=Uᵢₙ×Iₛ/2 is received by the inductance L1. With Iₛ=Uᵢₙ×tₒₙ/L, that gives: P=0.5×Uᵢₙ²×tₒₙ/L, wherein L is the inductance value of the inductance L1. It will be seen that the received power is independent of parameters of the fluorescent lamp 1. With an inductance L which is assumed to be constant, it is constant as long as tₒₙ and Uᵢₙ are not changed. During the switch-on duration ton the fluorescent lamp 1 is connected to the charged storage capacitor C3.

At the time t1 the choke L1 begins to discharge. During the switch-off duration t_{off} the choke current I falls until at t2 it reaches substantially zero. The falling current configuration and thus the switch-off time duration t_{off} depends on the parameters of the fluorescent lamp 1, in particular the lamp resistance thereof.

When the current I of the inductance L1 reaches approximately zero then the current of the inductance L2 correspondingly goes through zero. That is detected by the electronic control system 3 which now switches the switch V3—at the time t2—into the conducting condition again so that the described procedure is periodically repeated.

To simplify the illustration, only two respective periods are shown in each of FIGS. 5a to 5d.

The frequency f of the period is: f=1/(tₒₙ+t_{off}); the frequency is preferably >100 kHz and is for example of the order of magnitude of 500 kHz. At such high frequencies the inductances L1 and L2 can be of a compact and light nature.

In order to dim the fluorescent lamp 1 the power P made available to it is altered. For that purpose, the switch-on duration tₒₙ which is set by means of the electronic control system 3 is changed. In FIG. 5b the switch-on duration tₒₙ′ is shortened for example beginning at the time t4. Accordingly, at the time t5, only the reduced current Iₛ′ is reached so that—with the same lamp parameters—t_{off}′ is also shortened in relation to t_{off}. At the time t6 the current is at zero and the electronic control system 3 correspondingly switches the switch V3 into the conducting condition again for the next switch-on duration tₒₙ′.

FIG. 5c shows the current rise as in FIG. 5a; in FIG. 5c however, subsequently to t1, the current fall is shallower than in FIG. 5a, for example because the lamp resistance has fallen for some reasons and therefore the voltage at the capacitor C3 has also fallen so that there is a switch-off time duration t_{off}″ which is prolonged in relation to FIG. 5a.

FIG. 5d shows the current configuration as shown in FIG. 5c but by a reduction in the length of the switch-on duration tₒₙ′ in the dimmed condition.

The described dimming effect by way of the power which is made available makes it possible to achieve a very wide dimming range, for example from 100% to <0.1% without flicker phenomena occurring.

Dimming of the fluorescent lamp 1 can be effected in accordance with the foregoing equation in respect of the power P additionally or solely by changing the voltage Uᵢₙ.

In order to avoid dissociation of the lamp gases (cataphoresis) by the dc voltage operation of the fluorescent lamp 1, the fluorescent lamp 1 can periodically experience pole reversal. The frequency in that respect is substantially less than the above-specified frequency f=1/(tₒₙ+t_{off}). FIGS. 2 and 3 in that respect show a pole reversal stage with full bridge 10 which is controlled by the electronic control system 3. That is illustrated in FIG. 4 by the switches V5, V6, V7 and V8 which are controlled alternately by the electronic control system 3.

Heating of the electrodes of the fluorescent lamp 1 is preferably effected with direct current and/or dc voltage which is produced in potential-separated fashion in switching regulators 11, 12, or in pulse width modulation (PWM). The switching regulators 11, 12 are supplied from the separation stage 6 and are controlled by the electronic control system (see FIGS. 3 and 4). Direct current heating reduces the emitted interference levels.

In order to achieve low dimming levels, phases without switching on the switch V3 can be provided in the above-described procedure.

Prior to the above-mentioned pole reversal procedure the lamp 1 can be briefly operated with low-frequency alternating current. That makes it possible to render invisible so-called column jumps which otherwise occur, in the electrode region.

1. An operating circuit for a gas discharge lamp, such as a fluorescent lamp, especially for applications in the aeronautical field, wherein an inductance is connected upstream of the gas discharge lamp and a switch periodically controlled by an electronic control system controls the current through the inductance,
wherein upon the switch (V3) being switched into a conducting condition by the electronic control system (3) a constant dc voltage (Uᵢₙ) of a dc voltage source (4) is applied to the inductance (L1) for a constant switch-on duration (tₒₙ), the switch (V3) upon being switched off at the end of the switch-on duration (tₒₙ) causes the energy stored by the inductance (L1) to be discharged to the gas discharge lamp (1), and that in each case after discharge of the inductance (L1) to the gas discharge lamp (1) the electronic control system (3) closes the switch (V3) periodically again for the switch-on duration (tₒₙ).

2. An operating circuit according to claim 1 wherein the constant dc voltage (Uᵢₙ) and the constant switch-on duration (tₒₙ) are selectively adjustable for dimming the gas discharge lamp (1).

3. An operating circuit according to claim 1 wherein the inductance (L1) at the constant dc voltage (Uᵢₙ) and the set constant switch-on duration (tₒₙ) causes the current (I) to rise selectively linearly or non-linearly.

4. An operating circuit according to claim 1, wherein the electronic control system (3) detects discharge of the inductance (L1) by detection of the current crossing through zero.

5. An operating circuit according to claim 1, wherein the electronic control system (3) detects discharge of the inductance (L1) through a secondary winding (L2) of a transformer having a primary winding which forms the inductance (L1).

6. An operating circuit according to claim 1, wherein the frequency (f) of periodic switching of the switch (V3) is greater than 100 kHz.

7. An operating circuit according to claim 1, wherein connected in parallel with the gas discharge lamp (1) is a storage capacitor (C3) having a diode (V4) connected upstream thereof.

8. An operating circuit according to claim 1, wherein the dc voltage source (4) is selectively a battery or a dc voltage network or an ac network with a rectifier stage.

9. An operating circuit according to claim 1, wherein a pole reversal stage (10) is connected between the inductance (L1) and the gas discharge lamp (1).

10. An operating circuit according to claim 1, wherein heating of electrodes of the gas discharge lamp (1) is selectively effected by direct current, dc voltage or in pulse width modulation (PWM).

11. An operating circuit according to claim 1, wherein phases without the switch (V3) being switched on occur in the operating circuit.

12. An operating circuit according to claim 9, wherein before the actual pole reversal procedure the gas discharge lamp (1) is operated briefly at low-frequency alternating current in order to render column jumps invisible in an electrode region of said lamp.

13. A method of operating a gas discharge lamp, such as a fluorescent lamp, especially for applications in the aeronautical field, wherein an inductance is connected upstream of the gas discharge lamp and a switch periodically controlled by an electronic control system controls the current through the inductance,
wherein upon the switch (V3) being switched into a conducting condition by the electronic control system (3) this causes a constant dc voltage (Uᵢₙ) of a dc voltage source (4) to be applied to the inductance (L1) for a constant switch-on duration (tₒₙ), such that by the switch (V3) being switched off at the end of the switch-on duration (tₒₙ) the energy stored by the inductance (L1) is discharged to the gas discharge lamp (1), and that in each case after discharge of the inductance (L1) to the gas discharge lamp (1) the switch (V3) is closed by the electronic control system (3) periodically again for the switch-on duration (tₒₙ).
